(19) United States
(12) Patent Application Publication
(10) Pub. No.: US 2012/0005591 A1
(43) Pub. Date: Jan. 5, 2012

(54) Method and Apparatus for Presenting User Information Based on User Location Information

(75) Inventor: Mikko Antero Nurmi, Tampere (FI)

(73) Assignee: NOKIA CORPORATION, Espoo (FI)

(21) Appl. No.: 12/827,558

(22) Filed: Jun. 30, 2010

(51) Int. Cl. G06F 3/01

(52) U.S. Cl. 715/744

(57) ABSTRACT

An approach is provided for determining location information and presenting user information on at least one display. A location detection and presentation module determines location information of one or more users. The location detection and presentation module causes, at least in part, presentation of user information on at least one display at a position based, at least in part, on the determined location of the one or more users.

### BACKGROUND

Consumers utilize electronic entertainment systems for engaging with a wide range of gaming and entertainment applications. Most electronic game and entertainment applications allow for one or more users to participate. The users utilize system controllers to interact with the system for providing input and receiving feedback. Further, the systems present different types of user information,—such as users' score, users' name, users' avatar, etc.—on a display. Unfortunately, such user information is presented without regard to the users' positions in relation to the display. Consequently, the display of the user information is not optimized for the users' viewing experience, which may hinder the users' performance and participation in the applications.

### SOME EXAMPLE EMBODIMENTS

Therefore, there is a need for an approach for determining user location and presenting user information on one or more displays based on the determined user location.

According to one embodiment, a method comprises determining location information of one or more users. The method further comprises causing, at least in part, presentation of user information on at least one display at a position based, at least in part, on the determined location of the one or more users.

According to another embodiment, an apparatus comprising at least one processor, and at least one memory including computer program code for one or more programs, the at least one memory and the computer program code configured to, with the at least one processor, cause, at least in part, the apparatus to determine location information of one or more users. The apparatus is also caused, at least in part, to present user information on at least one display at a position based, at least in part, on the determined location of the one or more users.

According to another embodiment, a computer-readable storage medium carrying one or more sequences of one or more instructions which, when executed by one or more processors, cause, at least in part, an apparatus to determine location information of one or more users. The apparatus is also caused, at least in part, to present gaming information on at least one display at a position based, at least in part, on the determined location of the one or more users.

According to another embodiment, an apparatus comprises means for determining location information of one or more users. The apparatus further comprises means causing, at least in part, presentation of gaming information on at least one display at a position based, at least in part, on the determined location of the one or more users.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a entertainment setup capable of determining user location information and presenting user information on one or more displays based on the user location information, according to one embodiment;

FIG. 2 is a diagram of components of a gaming system capable of determining user location information and presenting user information on one or more displays based on the user location information, according to one embodiment.

FIG. 3 is a flowchart of a process for determining user location and presenting user information, according to one embodiment;

FIGS. 4A and 4B are flowcharts of processes for determining and positioning of user information, according to one embodiment;

FIG. 5 is a flowchart of a process for presenting user information based on user location determined using image and/or audio detection, according to one embodiment;

FIG. 6 is a flowchart of a process for presenting user information based on user location determined using wireless location schemes, according to one embodiment;

FIG. 7 is a flowchart of a process for presenting user information based on user location determined using both image detection and wireless location schemes, according to one embodiment;

FIG. 8 is a diagram of a gaming system, a display and users, according to one embodiment;

FIG. 9 is a diagram of a gaming setup in a gaming area, according to one embodiment;

FIG. 10 is a diagram of hardware that can be used to implement an embodiment of the invention;

FIG. 11 is a diagram of a chip set that can be used to implement an embodiment of the invention; and

FIG. 12 is a diagram of a mobile terminal (e.g., handset) that can be used to implement an embodiment of the invention.

### DESCRIPTION OF SOME EMBODIMENTS

Examples of a method, apparatus, and computer program for an entertainment system capable of presenting user information on one or more displays based on one or more user locations are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

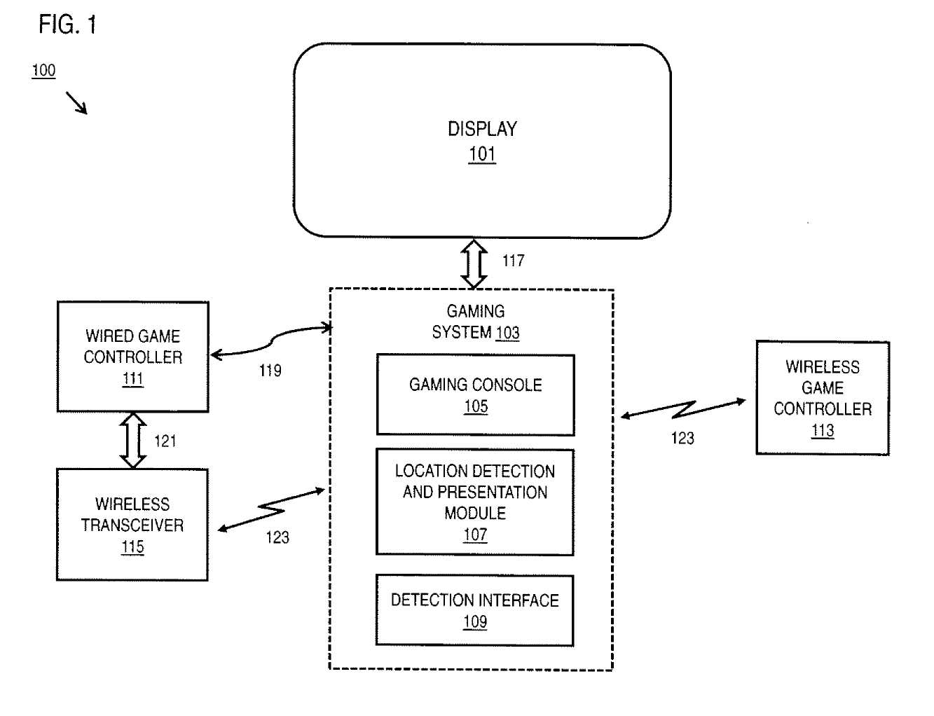

FIG. 1 is a diagram of an entertainment setup 100 capable of determining user location information and presenting user information on one or more displays based on the user location information, according to one embodiment. The entertainment setup 100 includes a gaming system 103; however, other systems such as a musical system, a learning system, a sharing system and/or the like can be included in the entertainment setup. As gaming systems have gained more processing and computing power, gaming applications have become more complex and allow one or more users to partake. The one or more users can be co-located in one gaming area or can be at different locations participating in the game through a network connection. The users can utilize many different types of game controllers, being wired and/or wireless, to interact with the gaming applications. Also, one or more users can play against the game console rendering it a multiuser game. Further, the gaming applications are capable of presenting on one or more displays one or more user information per one or more users at one or more predetermined locations on the one or more displays. The user information can include, but not limited to, a user name, a user avatar, status of the avatar, user score, user ranking, remaining game time, and/or the like. However, the user information is displayed at the one or more predetermined display locations even if the one or more users change their physical locations in reference to the one or more displays in the gaming area, hence, making it difficult for the one or more users to track the presentation of their own user information on the one or more displays.

In one embodiment, the entertainment setup 100 includes a gaming system 103, which is coupled via an interface 117 to a display 101. The gaming system can be coupled to one or more displays and the one or more displays can be any type and any combinations of TVs, computer monitors, CRTs, LCDs, projection type displays and/or the like. Further, the gaming system 103 is coupled with a wired game controller 111 (also referred to as game controller 111), a wireless game controller 113 (also referred to as game controller 113), and a wireless transceiver 115 (also referred to as transceiver 115). The wireless game controller 113 can include any wireless device, such as a mobile phone, a PDA and/or the like. The transceiver 115 can be a module which can be used in conjunction with one or more wired game controllers such as controller 111 and/or with wireless game controllers which do not include such a transceiver module yet. The wired game controller 111 is coupled with the gaming system 103 via a wired interface 119; the wireless game controller 113 and the wireless transceiver 115 are communicatively coupled with the gaming system 103 via a wireless interface 123 such as Bluethooth®, IrDA®, and/or any other wireless communication standard or any wireless method. In another embodiment, the gaming system 103 includes a gaming console 105, a location detection and presentation module 107, and a detection interface 109. For example, the gaming console 105 can be a computer, Playstation®, a Wii® game console or a mobile phone (for example, capable of projecting onto a display) capable of running electronic games from a local storage, a remote storage, a local media, an online game and/or the like. The location detection and presentation module 107 is capable of determining location information of a user and/or a user's device wirelessly in a gaming area and providing location and/or presentation information to the gaming console 105. Furthermore, the gaming console 105 can utilize the location information of a user and/or a user's device to determine location position on the display for one or more users. In one embodiment, the location detection of a user and/or a user device is achieved by a triangulation method and in another embodiment it is achieved by one or more wireless sensors employing one or more communication standards such as Bluetooth®, IrDA® and/or radio frequency identification (RFID)). In another embodiment, detection interface 109 is utilized to detect the location of a user in the gaming area. The detection interface 109 can include a standard web camera, one or more imaging devices, one or more audio devices (for example one or more wired and/or wireless microphones), motion detector, body/image-outline tracking device, and/or can include other and more advanced technologies to detect one or more users and track the one or more users' movements. Also, components of the detection interface 109 can be as an integrated device, for example an imaging device with audio recording capability, or can be separate devices such as an imaging device and an audio recording device. In one embodiment, the detection interface 109 is capable of capturing images, capturing audio, digitizing the images and/or the audio, and communicating the data back to the gaming console 105 and in another embodiment the detection interface 109 transmits the captured data back to the gaming console 105 for digitization. It should be understood that either or both of the location detection and presentation module 107, and the detection interface 109 can be integrated into the gaming console or can be placed in any other proximate location that will allow them to communicate with the gaming console 105. Furthermore, it should be understood that there can be multiple instances of the location detection and presentation module 107, the detection interface 109, the wired game controller 111, the wireless game controller 113, and the wireless transceiver 115. In another embodiment, one or more wireless transceivers and/or sensors can be utilized to create, in a gaming area, a wireless grid that will detect the location of a user and/or a user device.

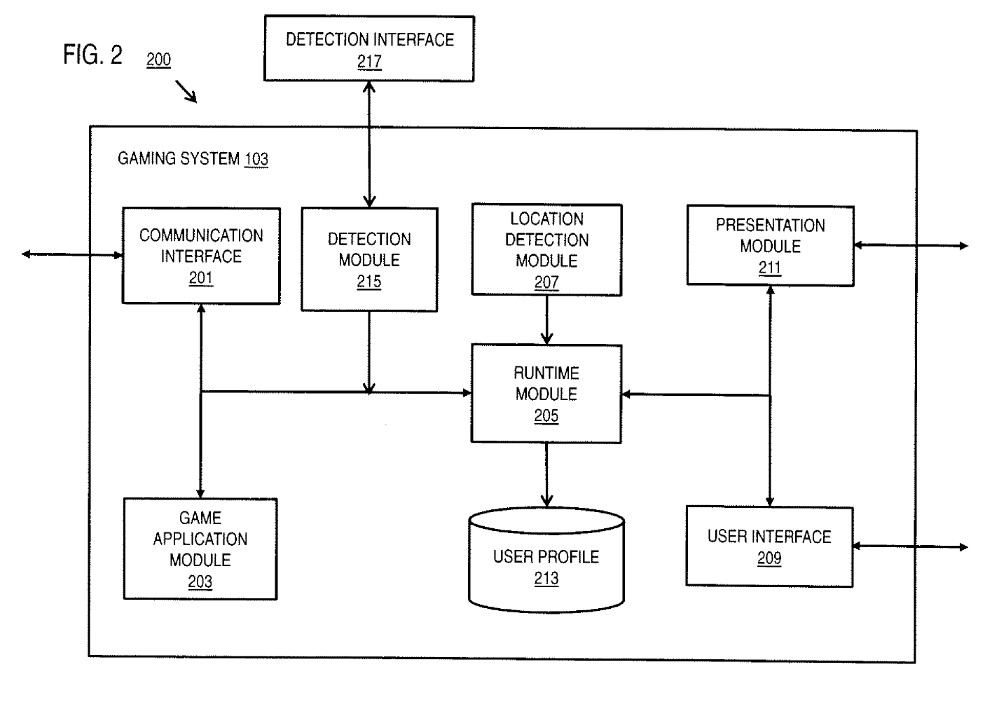

FIG. 2 is a diagram 200 of components of a gaming system 103 capable of determining user location information and presenting user information on one or more displays based on the user location information, according to one embodiment. By way of example, gaming system 103 includes one or more components for determining one or more user location information and presenting the user information for the one or more users on one or more displays based the one or more user location information. It is contemplated that the functions of these components may be combined in one or more components or performed by other components of equivalent functionality. In this embodiment, the gaming system 103 includes a communication interface 201, a game application 203, a runtime module 205, location detection module 207, a user profile 213, a presentation module 211, a user interface 209, and detection module 215. Also, a detection interface 217 is shown in the diagram 200.

In one embodiment, the communication interface 201 can be used to communicate with one or more other gaming systems and/or one or more gaming applications providers. Certain communications can be via methods such as an internet protocol, messaging, or any other communication method. In some examples, the one or more users can send a query or a request to play one or more games with one or more users at one or more other gaming systems. Further, the one or more users can request gaming applications or other contents from one or more online services via the communication interface 201.

The game application module 203 can accept one or more game applications input via a media player; such as a compact disc, a memory card, a memory stick and/or the like; can store one or more game applications from the media and/or can store one or more game applications downloaded via the communication interface 201. The gaming applications are then executed on the runtime module 205. For example, a game application is obtained from a compact disc and executed on the runtime module 205, which then begins other processes in the gaming system.

In one embodiment, the detection module 215 can be used to receive and process one or more images and/or one or more audio data received from the detection interface 217. The detection interface 217 can include logic required for image and audio processing; such as receive, digitize, compare, correct and/or the like; and making the data available for use by the location detection module 207.

In one embodiment, the location detection module 207 can utilize one or more images and/or one or more audio data, received from the detection module 215, to determine the location of one or more users in a gaming area.

In one embodiment, the user profile 213 can store user information for future use. For example, user profile can include user name, user image, user voice, user avatar, user game statistics, user preferences and/or the like.

In one embodiment, a combination of one or more sensors, such as microphones, is utilized to determine and track the location of the one or more users in the gaming area.

In one embodiment, the presentation module 211 presents one or more user information based on one or more user location information. For example, the presentation module 211 receives location information from location detection module for one or more users and presents user information for the one or more users based on the one or more use locations.

The user interface 209 can include various methods of communication. For example, the user interface (UI) 209 can have outputs including a visual component (e.g., a screen), an audio component, a physical component (e.g., vibrations), and other methods of communication. User inputs can include a touch-screen interface, voice input, gesture based interface, a scroll-and-click interface, a button interface, a microphone, biosignal based inputs (for example human electronic brain signals, eye parameters, etc.) and/or the like. Moreover, the user interface 209 may be used to prompt the user to enter local credentials (e.g., a PIN code, biometric sensor input, etc.) and receive local credentials from the user. The communication can be via a wired or a wireless interface. The UI 209 can be located on one device, multiple devices, at one location, at multiple locations and can be shared by one or more users.

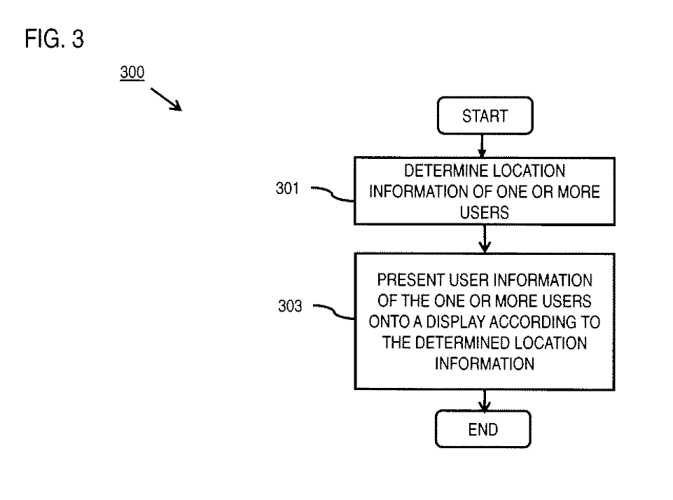

FIG. 3 is a flowchart of a process 300 for determining user location and presenting user information, according to one embodiment.

At step 301, location information of one or more users in a gaming area is determined. The location information of the one or more users is information regarding their physical location in the gaming area in reference to the display 101. The location information can be obtained by a detection interface which can detect the location of the one or more users and/or by a wireless scheme which can detect the location of one or more wireless transceivers 115 and/or one or more wireless game controllers 113. At step 303, the user information for the one or more users is presented onto one or more displays based on the one or more user location information. In an example scenario, there are three users sitting in position sequence of 1, 2 and 3. Once their locations are detected by the detection interface 109 and/or a wireless scheme, the location detection and presentation module 107, causes the user information for the three users be displayed in a sequence of 1, 2 and 3 such that each user is substantially across and/or closest to their respective user information.

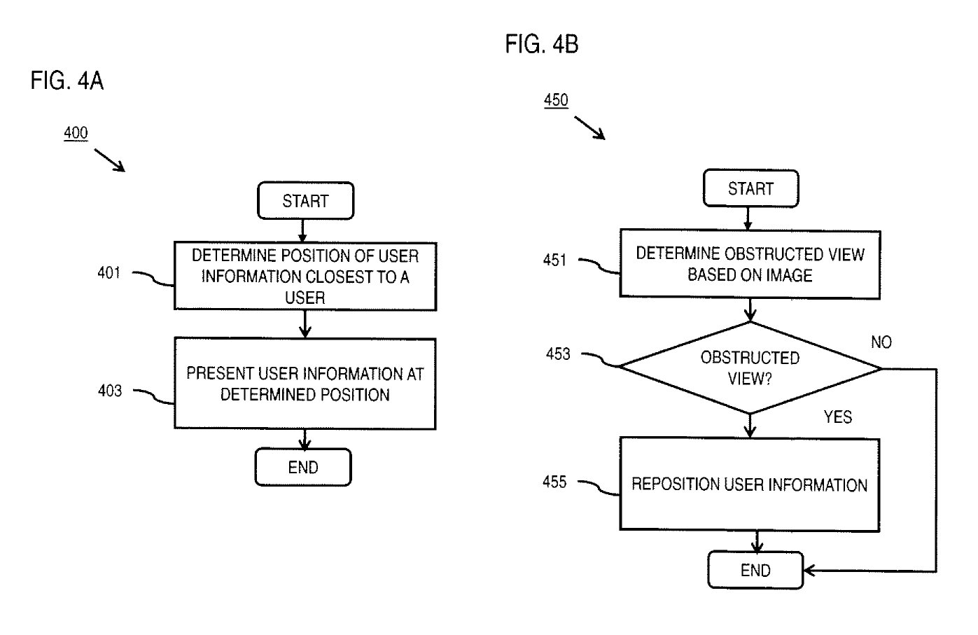

FIGS. 4A and 4B are flowcharts of processes for determining and positioning of user information, according to one embodiment.

Specifically, FIG. 4A shows a process 400 for determining position of user information closest to the user, according to one embodiment.

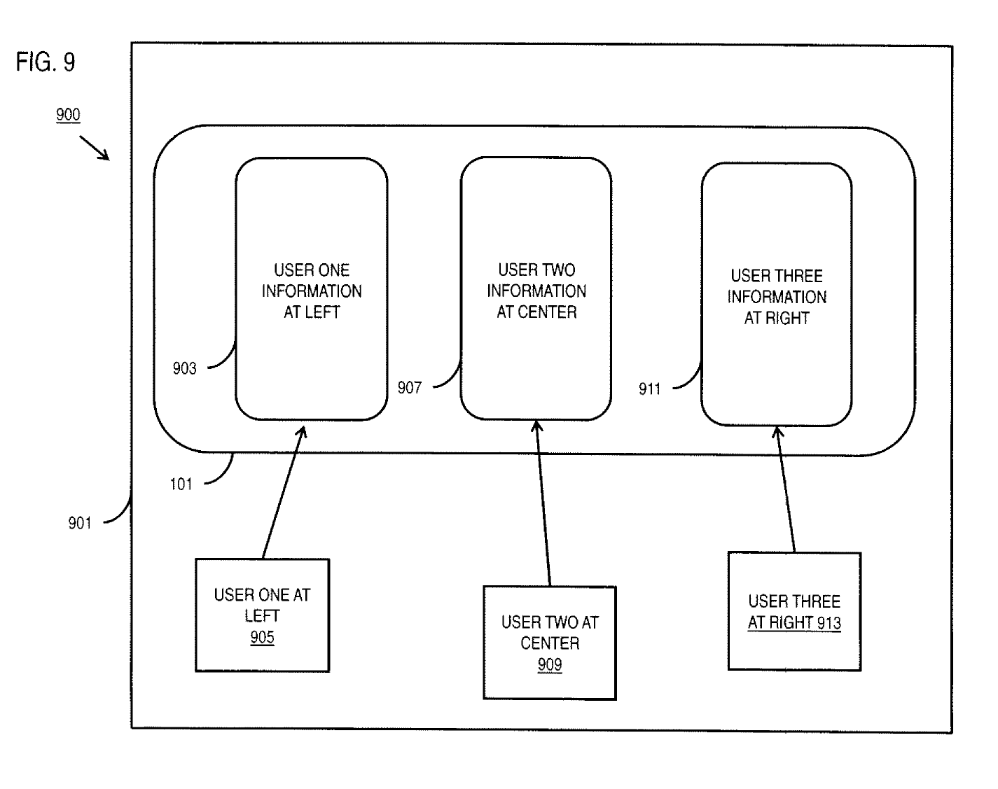

At step 401, one or more display locations on the display 101 are determined such that the one or more display locations have closest distance to the one or more users. The closest distance, in one embodiment, can be calculated by comparing the location of a given user to the nearest display location. Considering gaming setup 900 of FIG. 9 for an example, there are three users; user one 905 at left, user two 909 at center and user three 913 at right; in the gaming area 901 located in front of the display 101 with locations at left, center and right relative to the display. Their three respective user information—903, 907 and 911—are displayed on the left, center and right relative to the display which are substantially closest to physical location of each user.

At step 403, the one or more user information are presented on the display 101 for the one or more users. For example, the user information for a user closest to a left side (when looking at the display) of the display would be displayed on the display closest to the left side of the display.

FIG. 4B is a flowchart of process 450 for determining an obstructed view, according to one embodiment. The process shows steps for determining if a user's view of the user information on the display is obstructed, for example, by another user, by an object and/or the like. An obstruction is determined when the one or more images of the one or more users previously captured, by the detection interface, do not substantially match to one or more images currently captured by the detection interface. For example, an image for a given user is partially or substantially obstructed by another user or an object, such that the given user cannot be recognized by the gaming system 103.

At step 451, location detection and presentation module 107 determines if one or more user's view of the user information on the display 101 is obstructed. For example, the detection interface 109 can capture the images of the one or more users, periodically or continuously, and compare to previously captured images and determine if the newly captured images of the one or more users indicate any obstructions. At step 453, if it is determined that the view is obstructed, then at step 455, the user information is repositioned on the display 101 to a new display location.

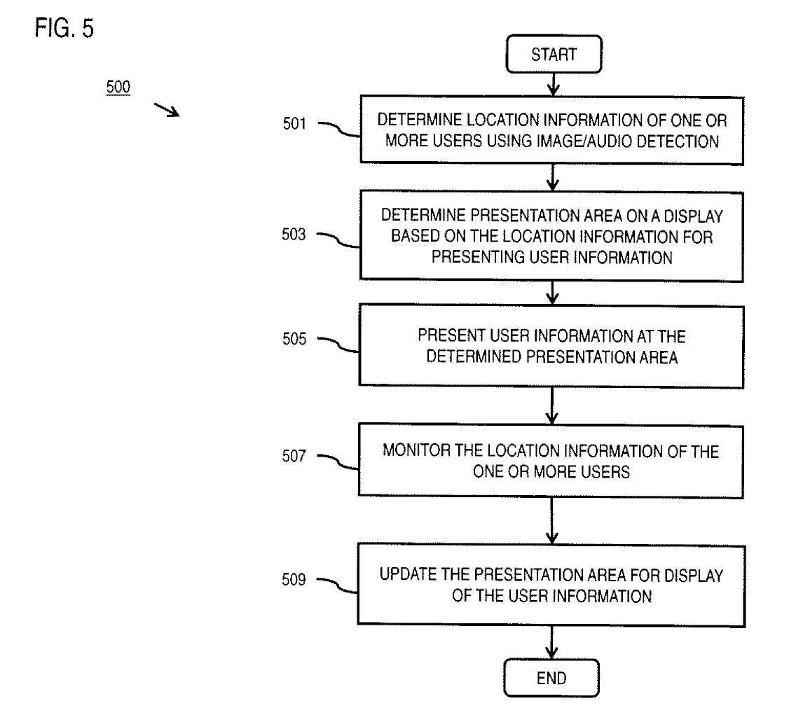

FIGS. 5-7 are flowcharts of processes for determining user location and presenting user information, according to one embodiment. The process can be performed by a combination of one or more user devices and a gaming system. The processes show steps for acquiring user and/or user device location for one or more users in a gaming area, determining a display location on one or more displays and displaying one or more user information on the one or more displays for the one or more users.

FIG. 5 is a flowchart of process 500 for determining location information of one or more users using image and/or audio detection.

At step 501, location detection and presentation module 107 and detection interface 109 determine location information of one or more users in a gaming area by capturing one or more images and/or one or more audio data of the one or more users. In one embodiment, the detection interface 109 utilizes one or more image processing schemes such as one or more facial recognition algorithms including signal/image processing, computer vision, pattern recognition, statistical analysis and/or the like. In another embodiment, the detection interface 109 utilizes one or more audio capturing techniques including audio recording, voice recognition, audio/signal processing, statistical analysis and/or the like.

At step 503, location detection and presentation module 107 determines one or more presentation areas for the one or more user information based on the location information of the one or more users. At step 505, the user information is presented according to presentation area determined at step 503.

At step 507, the location detection and presentation module 107 and detection interface 109 monitor the one or more location information of the one or more users and at step 509, the user information is presented at the display presentation area determined at step 507.

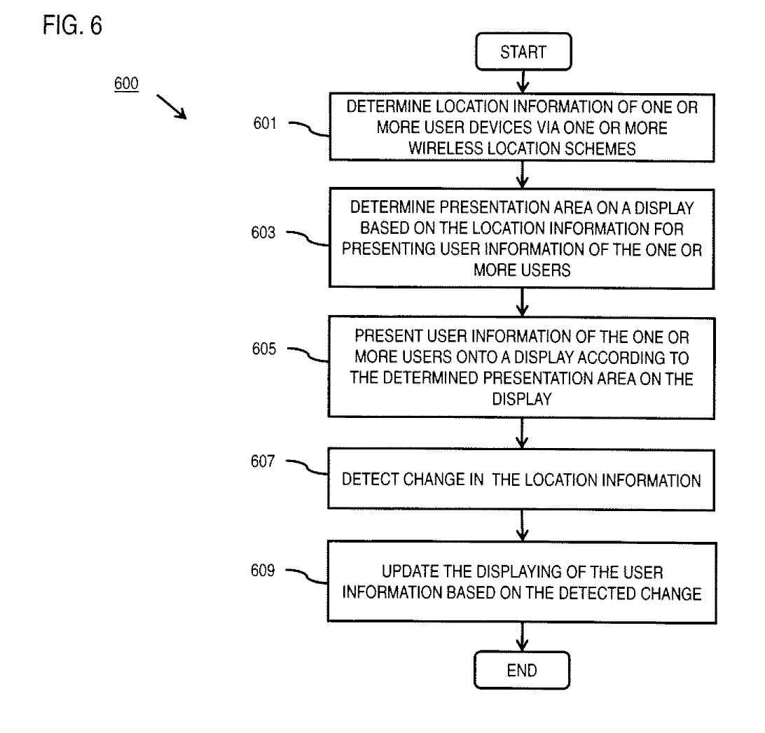

FIG. 6 is a flowchart of process 600 for determining location information of one or more user devices via one or more wireless location schemes.

At step 601, location detection and presentation Module 107 and wireless transceiver 115 determine location information of one or more users in a gaming area by utilizing one or more wireless schemes. In one embodiment, one or more wireless technologies are utilized to triangulate and determine the location information. In another embodiment, one or more sensors and one or more transceivers are utilized to form a wireless grid in the gaming area and determine the location information. The sensors and the transceivers can be integrated or external or partially integrated and can be wired or wireless or some combination of the foregoing.

At step 603, location detection and presentation module 107 determines one or more presentation areas for the one or more user information based on the location information of the one or more users. At step 605, the user information is presented according to presentation area determined at step 603.

At step 607, the location detection and presentation module 107 and wireless transceiver 115 monitor the one or more location information of the one or more users and at step 609, the user information is presented at the display presentation area determined at step 607.

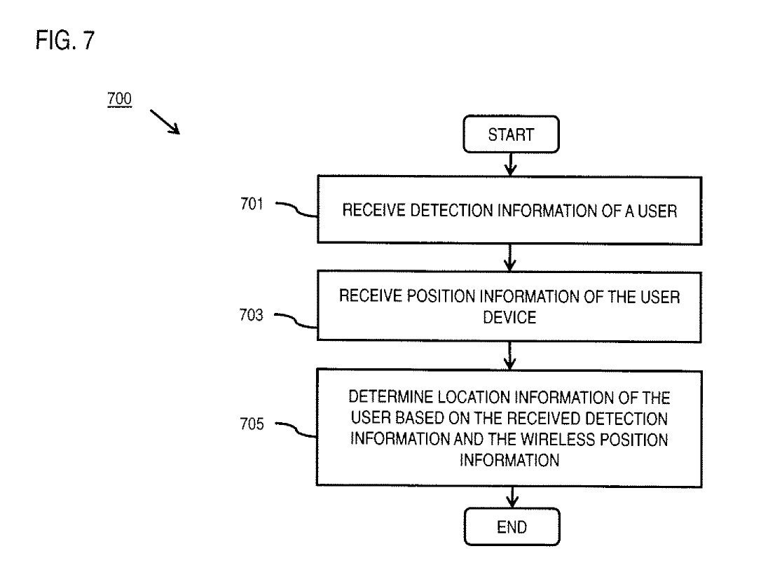

FIG. 7 is a flowchart of process 700 for determining location information of one or more users and one or more devices using image/audio detection and one or more wireless location schemes.

At step 701, location detection and presentation module 107 and detection interface 109 determine location information of one or more users in a gaming area by capturing one or more images and/or one or more audio data of the one or more users.

At 703, location detection and presentation module 107 and wireless transceiver 115 determine location information of one or more users in a gaming area by utilizing one or more wireless schemes.

At 705, location detection and presentation module 107 determines location information of one or more users in a gaming area based on the image/audio location information and the wireless location information.

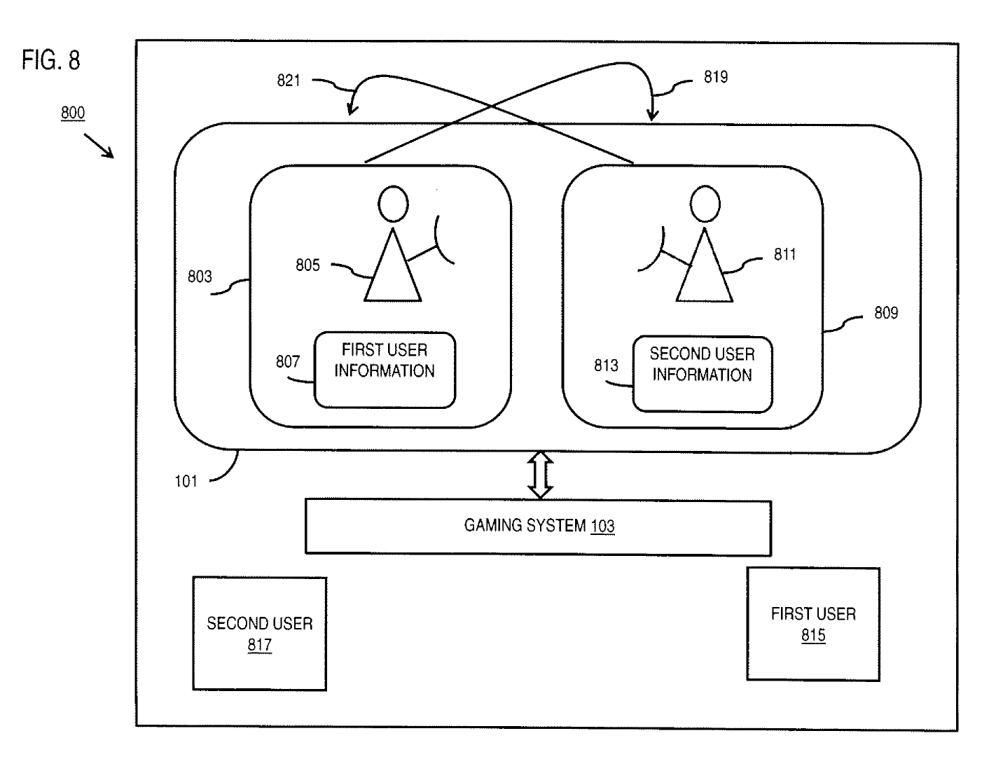

FIG. 8 is a diagram of a gaming area 800, according to one embodiment. When one or more users begin playing a game, they can be located anywhere in a gaming area. In reference to the display 101 display area, the users can be closer to the left side, closer to the right side, closer to the bottom side or closer to the top side. In one embodiment, in a gaming area 800, a first user 815 and a second user 817 are communicatively coupled to the gaming system 103. The gaming system 103 is interfacing with the display 101. The first user 815 and second user 817 are playing a video game being executed on the gaming system 103. Display information 803 shows one or more user information, avatar 805 and user information 807, substantially on a left side of the display 101 and display information 809 shows one or more user information, avatar 811 and user information 813, substantially on a right side of the display 101. As shown, the user information for the first user and the second user are at a display location across from their location in reference to the display 101. In one embodiment, execution of process 600 of FIG. 6 will reposition the display information 803 substantially to right side of the display 101 display area will reposition the display information 809 substantially to left side of the display 101 display area. For example, the first user will substantially be closer to first user's display information 803 and the second user will substantially be closer to second user's display information 809. In another embodiment, a first user is in a gaming area and one or more users are at different locations and are participating in a game via an online method—such as an online gaming center or connecting to the gaming system via internet. The first user's location in the gaming area is determined and the first user's information is displayed onto one or more displays according to the determined location. In another embodiment, one or more users are playing against one or more gaming systems/computers. The location of the one or more users is determined and user information for the one or more users is displayed onto one or more displays according to the determined locations.

The processes described herein for presenting location information may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

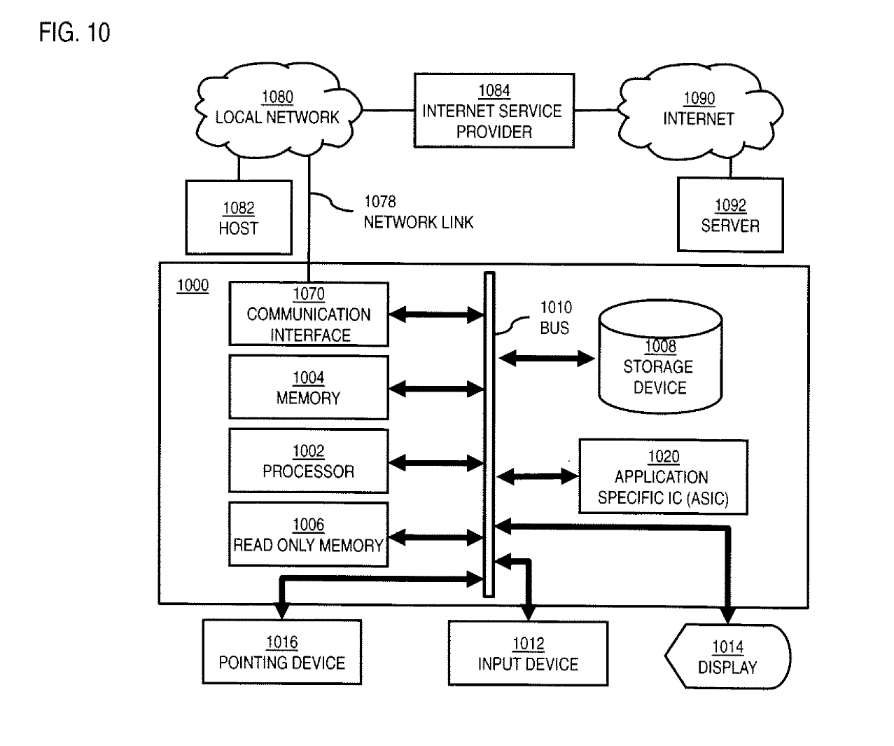

FIG. 10 illustrates a computer system 1000 upon which an embodiment of the invention may be implemented. Although computer system 1000 is depicted with respect to a particular device or equipment, it is contemplated that other devices or equipment (e.g., network elements, servers, etc.) within FIG. 10 can deploy the illustrated hardware and components of system 1000. Computer system 1000 is programmed (e.g., via computer program code or instructions) to determine one or more user location and present one or more user information on one or more displays based on the one or more determined locations as described herein and includes a communication mechanism such as a bus 1010 for passing information between other internal and external components of the computer system 1000. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1000, or a portion thereof, constitutes a means for performing one or more steps of determining one or more user location and presenting one or more user information on one or more displays based on the one or more determined locations.

A bus 1010 includes one or more parallel conductors of information so that information is transferred quickly among devices coupled to the bus 1010. One or more processors 1002 for processing information are coupled with the bus 1010.

A processor (or multiple processors) 1002 performs a set of operations on information as specified by computer program code related to determining one or more user location and presenting one or more user information on one or more displays based on the one or more determined locations. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1010 and placing information on the bus 1010. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1002, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1000 also includes a memory 1004 coupled to bus 1010. The memory 1004, such as a random access memory (RAM) or other dynamic storage device, stores information including processor instructions for determining one or more user location and presenting one or more user information on one or more displays based on the one or more determined locations. Dynamic memory allows information stored therein to be changed by the computer system 1000. RAM allows a unit of information stored at a location called a memory address to be stored and retrieved independently of information at neighboring addresses. The memory 1004 is also used by the processor 1002 to store temporary values during execution of processor instructions. The computer system 1000 also includes a read only memory (ROM) 1006 or other static storage device coupled to the bus 1010 for storing static information, including instructions, that is not changed by the computer system 1000. Some memory is composed of volatile storage that loses the information stored thereon when power is lost. Also coupled to bus 1010 is a non-volatile (persistent) storage device 1008, such as a magnetic disk, optical disk or flash card, for storing information, including instructions, that persists even when the computer system 1000 is turned off or otherwise loses power.

Information, including instructions for determining one or more user location and presenting one or more user information on one or more displays based on the one or more determined locations, is provided to the bus 1010 for use by the processor from an external input device 1012, such as a keyboard containing alphanumeric keys operated by a human user, or a sensor. A sensor detects conditions in its vicinity and transforms those detections into physical expression compatible with the measurable phenomenon used to represent information in computer system 1000. Other external devices coupled to bus 1010, used primarily for interacting with humans, include a display device 1014, such as a cathode ray tube (CRT) or a liquid crystal display (LCD), or plasma screen or printer for presenting text or images, and a pointing device 1016, such as a mouse or a trackball or cursor direction keys, or motion sensor, for controlling a position of a small cursor image presented on the display 1014 and issuing commands associated with graphical elements presented on the display 1014. In some embodiments, for example, in embodiments in which the computer system 1000 performs all functions automatically without human input, one or more of external input device 1012, display device 1014 and pointing device 1016 is omitted.

In the illustrated embodiment, special purpose hardware, such as an application specific integrated circuit (ASIC) 1020, is coupled to bus 1010. The special purpose hardware is configured to perform operations not performed by processor 1002 quickly enough for special purposes. Examples of application specific ICs include graphics accelerator cards for generating images for display 1014, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1000 also includes one or more instances of a communications interface 1070 coupled to bus 1010. Communication interface 1070 provides a one-way or two-way communication coupling to a variety of external devices that operate with their own processors, such as printers, scanners and external disks. In general the coupling is with a network link 1078 that is connected to a local network 1080 to which a variety of external devices with their own processors are connected. For example, communication interface 1070 may be a parallel port or a serial port or a universal serial bus (USB) port on a personal computer. In some embodiments, communications interface 1070 is an integrated services digital network (ISDN) card or a digital subscriber line (DSL) card or a telephone modem that provides an information communication connection to a corresponding type of telephone line. In some embodiments, a communication interface 1070 is a cable modem that converts signals on bus 1010 into signals for a communication connection over a coaxial cable or into optical signals for a communication connection over a fiber optic cable. As another example, communications interface 1070 may be a local area network (LAN) card to provide a data communication connection to a compatible LAN, such as Ethernet. Wireless links may also be implemented. For wireless links, the communications interface 1070 sends or receives or both sends and receives electrical, acoustic or electromagnetic signals, including infrared and optical signals, that carry information streams, such as digital data. For example, in wireless handheld devices, such as mobile telephones like cell phones, the communications interface 1070 includes a radio band electromagnetic transmitter and receiver called a radio transceiver. In certain embodiments, the communications interface 1070 enables connection to the communication network 105 for the UE 101.

The term “computer-readable medium” as used herein refers to any medium that participates in providing information to processor 1002, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1008. Volatile media include, for example, dynamic memory 1004. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1020.

Network link 1078 typically provides information communication using transmission media through one or more networks to other devices that use or process the information. For example, network link 1078 may provide a connection through local network 1080 to a host computer 1082 or to equipment 1084 operated by an Internet Service Provider (ISP). ISP equipment 1084 in turn provides data communication services through the public, world-wide packet-switching communication network of networks now commonly referred to as the Internet 1090.

A computer called a server host 1092 connected to the Internet hosts a process that provides a service in response to information received over the Internet. For example, server host 1092 hosts a process that provides information representing video data for presentation at display 1014. It is contemplated that the components of system 1000 can be deployed in various configurations within other computer systems, e.g., host 1082 and server 1092.

At least some embodiments of the invention are related to the use of computer system 1000 for implementing some or all of the techniques described herein. According to one embodiment of the invention, those techniques are performed by computer system 1000 in response to processor 1002 executing one or more sequences of one or more processor instructions contained in memory 1004. Such instructions, also called computer instructions, software and program code, may be read into memory 1004 from another computer-readable medium such as storage device 1008 or network link 1078. Execution of the sequences of instructions contained in memory 1004 causes processor 1002 to perform one or more of the method steps described herein. In alternative embodiments, hardware, such as ASIC 1020, may be used in place of or in combination with software to implement the invention. Thus, embodiments of the invention are not limited to any specific combination of hardware and software, unless otherwise explicitly stated herein.

The signals transmitted over network link 1078 and other networks through communications interface 1070, carry information to and from computer system 1000. Computer system 1000 can send and receive information, including program code, through the networks 1080, 1090 among others, through network link 1078 and communications interface 1070. In an example using the Internet 1090, a server host 1092 transmits program code for a particular application, requested by a message sent from computer 1000, through Internet 1090, ISP equipment 1084, local network 1080 and communications interface 1070. The received code may be executed by processor 1002 as it is received, or may be stored in memory 1004 or in storage device 1008 or other non-volatile storage for later execution, or both. In this manner, computer system 1000 may obtain application program code in the form of signals on a carrier wave.

Various forms of computer readable media may be involved in carrying one or more sequence of instructions or data or both to processor 1002 for execution. For example, instructions and data may initially be carried on a magnetic disk of a remote computer such as host 1082. The remote computer loads the instructions and data into its dynamic memory and sends the instructions and data over a telephone line using a modem. A modem local to the computer system 1000 receives the instructions and data on a telephone line and uses an infra-red transmitter to convert the instructions and data to a signal on an infra-red carrier wave serving as the network link 1078. An infrared detector serving as communications interface 1070 receives the instructions and data carried in the infrared signal and places information representing the instructions and data onto bus 1010. Bus 1010 carries the information to memory 1004 from which processor 1002 retrieves and executes the instructions using some of the data sent with the instructions. The instructions and data received in memory 1004 may optionally be stored on storage device 1008, either before or after execution by the processor 1002.

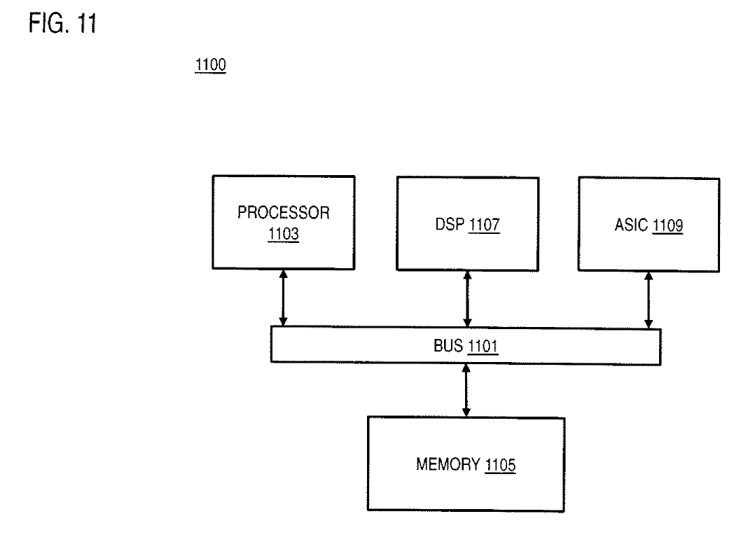

FIG. 11 illustrates a chip set or chip 1100 upon which an embodiment of the invention may be implemented. Chip set 1100 is programmed to determine one or more user location and present one or more user information on one or more displays based on the one or more determined locations as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1100 can be implemented in a single chip. It is further contemplated that in certain embodiments the chip set or chip 1100 can be implemented as a single “system on a chip.” It is further contemplated that in certain embodiments a separate ASIC would not be used, for example, and that all relevant functions as disclosed herein would be performed by a processor or processors. Chip set or chip 1100, or a portion thereof, constitutes a means for performing one or more steps of providing user interface navigation information associated with the availability of services. Chip set or chip 1100, or a portion thereof, constitutes a means for performing one or more steps of determining one or more user location and presenting one or more user information on one or more displays based on the one or more determined locations.

In one embodiment, the chip set or chip 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform the inventive steps described herein to determine one or more user location and present one or more user information on one or more displays based on the determined locations. The memory 1105 also stores the data associated with or generated by the execution of the inventive steps.

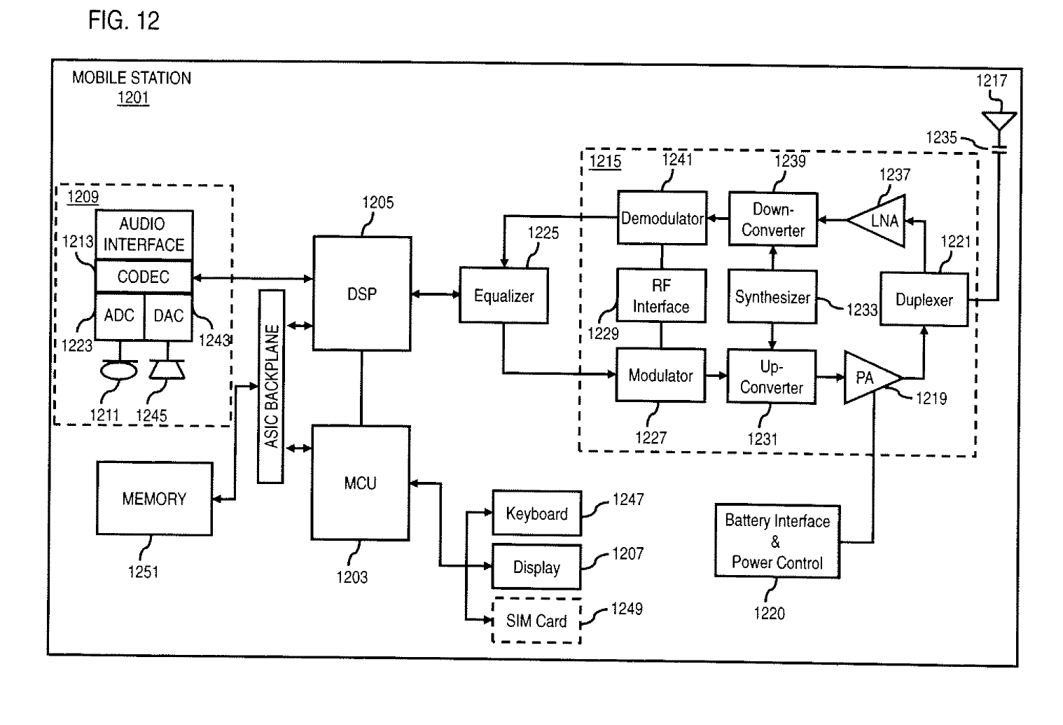

FIG. 12 is a diagram of exemplary components of a mobile terminal (e.g., handset) for communications, which is capable of operating in the system of FIG. 1, according to one embodiment. In some embodiments, mobile terminal 1200, or a portion thereof, constitutes a means for performing one or more steps of determining one or more user location and presenting one or more user information on one or more displays based on the one or more determined locations. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1203, a Digital Signal Processor (DSP) 1205, and a receiver/transmitter unit including a microphone gain control unit and a speaker gain control unit. A main display unit 1207 provides a display to the user in support of various applications and mobile terminal functions that perform or support the steps of determining one or more user location and presenting one or more user information on one or more displays based on the one or more determined locations. The display 1207 includes display circuitry configured to display at least a portion of a user interface of the mobile terminal (e.g., mobile telephone). Additionally, the display 1207 and display circuitry are configured to facilitate user control of at least some functions of the mobile terminal. An audio function circuitry 1209 includes a microphone 1211 and microphone amplifier that amplifies the speech signal output from the microphone 1211. The amplified speech signal output from the microphone 1211 is fed to a coder/decoder (CODEC) 1213.

A radio section 1215 amplifies power and converts frequency in order to communicate with a base station, which is included in a mobile communication system, via antenna 1217. The power amplifier (PA) 1219 and the transmitter/modulation circuitry are operationally responsive to the MCU 1203, with an output from the PA 1219 coupled to the duplexer 1221 or circulator or antenna switch, as known in the art. The PA 1219 also couples to a battery interface and power control unit 1220.

In use, a user of mobile terminal 1201 speaks into the microphone 1211 and his or her voice along with any detected background noise is converted into an analog voltage. The analog voltage is then converted into a digital signal through the Analog to Digital Converter (ADC) 1223. The control unit 1203 routes the digital signal into the DSP 1205 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1225 for compensation of any frequency-dependent impairments that occur during transmission though the air such as phase and amplitude distortion. After equalizing the bit stream, the modulator 1227 combines the signal with a RF signal generated in the RF interface 1229. The modulator 1227 generates a sine wave by way of frequency or phase modulation. In order to prepare the signal for transmission, an up-converter 1231 combines the sine wave output from the modulator 1227 with another sine wave generated by a synthesizer 1233 to achieve the desired frequency of transmission. The signal is then sent through a PA 1219 to increase the signal to an appropriate power level. In practical systems, the PA 1219 acts as a variable gain amplifier whose gain is controlled by the DSP 1205 from information received from a network base station. The signal is then filtered within the duplexer 1221 and optionally sent to an antenna coupler 1235 to match impedances to provide maximum power transfer. Finally, the signal is transmitted via antenna 1217 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1201 are received via antenna 1217 and immediately amplified by a low noise amplifier (LNA) 1237. A down-converter 1239 lowers the carrier frequency while the demodulator 1241 strips away the RF leaving only a digital bit stream. The signal then goes through the equalizer 1225 and is processed by the DSP 1205. A Digital to Analog Converter (DAC) 1243 converts the signal and the resulting output is transmitted to the user through the speaker 1245, all under control of a Main Control Unit (MCU) 1203—which can be implemented as a Central Processing Unit (CPU) (not shown).

The MCU 1203 receives various signals including input signals from the keyboard 1247. The keyboard 1247 and/or the MCU 1203 in combination with other user input components (e.g., the microphone 1211) comprise a user interface circuitry for managing user input. The MCU 1203 runs a user interface software to facilitate user control of at least some functions of the mobile terminal 1201 to determine one or more user location and present one or more user information on one or more displays based on the one or more determined locations. The MCU 1203 also delivers a display command and a switch command to the display 1207 and to the speech output switching controller, respectively. Further, the MCU 1203 exchanges information with the DSP 1205 and can access an optionally incorporated SIM card 1249 and a memory 1251. In addition, the MCU 1203 executes various control functions required of the terminal. The DSP 1205 may, depending upon the implementation, perform any of a variety of conventional digital processing functions on the voice signals. Additionally, DSP 1205 determines the background noise level of the local environment from the signals detected by microphone 1211 and sets the gain of microphone 1211 to a level selected to compensate for the natural tendency of the user of the mobile terminal 1201.

The CODEC 1213 includes the ADC 1223 and DAC 1243. The memory 1251 stores various data including call incoming tone data and is capable of storing other data including music data received via, e.g., the global Internet. The software module could reside in RAM memory, flash memory, registers, or any other form of writable storage medium known in the art. The memory device 1251 may be, but not limited to, a single memory, CD, DVD, ROM, RAM, EEPROM, optical storage, or any other non-volatile storage medium capable of storing digital data.

An optionally incorporated SIM card 1249 carries, for instance, important information, such as the cellular phone number, the carrier supplying service, subscription details, and security information. The SIM card 1249 serves primarily to identify the mobile terminal 1201 on a radio network. The card 1249 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
determining location information of one or more users; and
causing, at least in part, presentation of user information on at least one display at a position based, at least in part, on the determined location of the one or more users.

2. A method of claim 1, further comprising:
determining the position as a point closest to the user.

3. A method of claim 1, further comprising:
causing, at least in part, acquiring one or more images or one or more audio of the one or more users via an detection interface; and
verifying the one or more users based, at least in part, on the acquired image, the acquired audio, or a combination thereof.

4. A method of claim 3, further comprising:
determining that the one or more user has at least a partially obstructed view of the user information based on the acquired image; and
repositioning the user information on the display.

5. A method of claim 1, further comprising:
receiving a signal from a wireless transceiver wherein the location information is determined based, at least in part, on the received signal.

6. A method of claim 3, further comprising:
receiving a signal from a wireless transceiver wherein the location information is, at least in part, determined based on the received signal, the acquired image, the acquired audio, or a combination thereof.

7. A method of claim 1, further comprising:
detecting a change in the location information; and
causing, at least in part, position of the user information based on the detected change.

8. A method of claim 3, wherein the wireless transceiver is at least substantially included in a user device.

9. An apparatus comprising:
at least one processor; and
at least one memory including computer program code for one or more programs, the at least one memory and the computer program code configured to, with the at least one processor, cause the apparatus to perform at least the following,
determine location information of one or more users; and
cause, at least in part, presentation of user information on at least one display at a position based, at least in part, on the determined location of the one or more users.

10. An apparatus of claim 9, wherein the apparatus is further caused, at least in part, to:
determine the position as a point closest to the user.

11. An apparatus of claim 9, wherein the apparatus is further caused, at least in part, to:
cause, at least in part, acquire one or more images or one or more audio of the one or more users via an detection interface; and
verify the one or more users based, at least in part, on the acquired image, the acquired audio, or a combination thereof.

12. An apparatus of claim 11, wherein the apparatus is further caused, at least in part, to:
determine that the one or more user has at least a partially obstructed view of the user information based on the acquired image; and
reposition the user information on the display.

13. An apparatus of claim 9, wherein the apparatus is further caused, at least in part, to:
receive a signal from a wireless transceiver wherein the location information is determined based, at least in part, on the received signal.

14. An apparatus of claim 11, wherein the apparatus is further caused, at least in part, to:
receive a signal from a wireless transceiver wherein the location information is, at least in part, determined based on the received signal, the acquired image, the acquired audio, or a combination thereof.

15. An apparatus of claim 9, wherein the apparatus is further caused, at least in part, to:
detect a change in the location information; and
cause, at least in part, position of the user information based on the detected change.

16. An apparatus of claim 11, wherein the wireless transceiver is at least substantially included in a user device.

17. A computer-readable storage medium carrying one or more sequences of one or more instructions which, when executed by one or more processors, cause an apparatus to at least perform the following:
determining location information of one or more users; and
causing, at least in part, presentation of user information on at least one display at a position based, at least in part, on the determined location of the one or more users.

18. A computer-readable storage medium of claim 17, wherein the apparatus is caused, at least in part, to further perform:
causing, at least in part, acquire one or more images or one or more audio of the one or more users via an detection interface; and
verifying the one or more users based, at least in part, on the acquired image, the acquired audio, or a combination thereof.

19. A computer-readable storage medium of claim 17, wherein the apparatus is caused, at least in part, to further perform:
determining that the one or more user has at least a partially obstructed view of the user information based on the acquired image; and
repositioning the user information on the display.

20. A computer-readable storage medium of claim 17, wherein the apparatus is caused, at least in part, to further perform:
receiving a signal from a wireless transceiver wherein the location information is determined based, at least in part, on the received signal.

21.-41. (canceled)
